(19) United States
(12) Patent Application Publication
(10) Pub. No.: US 2026/0063094 A1
(43) Pub. Date: Mar. 5, 2026

(54) LUBRICANT DOSING DEVICE FOR GASEOUS FUEL ENGINE

(71) Applicant: PHINIA DELPHI LUXEMBOURG SARL, Belvaux (LU)

(72) Inventors: Philippe LEGRAND, St. Gervais la Foret (FR); Ludovic PERON, Lailly en Val (FR); Christophe TAPIN, Saint Sulpice de Pommeray (FR)

(21) Appl. No.: 19/106,871

(22) PCT Filed: Aug. 29, 2023
(86) PCT No.: PCT/EP2023/073576

§ 371 Date: Feb. 26, 2025

(30) Foreign Application Priority Data
Aug. 30, 2022 (GB) 2212556.1

(51) Int. Cl. F02M 25/00; F01M 1/02; F01M 1/16; F02M 21/02

(52) U.S. Cl. CPC F02M 25/00; F01M 1/02; F01M 1/16; F02M 21/0209; F02M 21/0221; F02M 21/0227; F02M 21/0239; F02M 21/0242; F01M 2001/023

(57) ABSTRACT

A lubricant dosing device for a gaseous fuel delivery system of an internal combustion engine, in particular a hydrogen engine, includes a body having therein a pumping bore extending along a pumping axis and defining, at an end, a pumping chamber which volume is varied by a piston reciprocating in the pumping bore. An inlet valve assembly is arranged in an inlet section. An outlet section includes an outlet valve assembly to control the discharge of pressurized lubricant fluid from the pumping chamber. The outlet valve assembly is configured as a check-valve with an outlet valve seat and an outlet valve member downstream thereof. The outlet valve member includes a sealing surface adapted to cooperate with the outlet valve seat the sealing surface being formed of or coated with a resilient polymer.

### FIELD OF THE INVENTION

The present invention generally relates to internal combustion engines and more particularly to gaseous fuel delivery systems for gaseous fuel engines, in particular hydrogen engines.

### BACKGROUND OF THE INVENTION

Currently, over 20% of global demand for energy is related to the transport sector which, to a significant extent, has been dominated by internal combustion engines, which can be operated using a wide range of fuels. In the past decades, there has been a significant increase in interest in gaseous fuels, such as compressed natural gas. But the need for alternative fuels has been growing in importance recently. This is connected not only with decreasing fossil fuel resources, but also with the growing concern for the natural environment and the fight against global warming.

In this context, hydrogen, leading to a cleaner combustion process, is foreseen as a realistic alternative to gasoline or diesel

However, hydrogen, and in general compressed or liquefied gases are relatively dry fuels, lacking lubricating compounds compared to gasoline or diesel. The service life and operational reliability of fuel injectors used with gaseous fuels are therefore limited. The lack of lubrication is even more problematic for fuel injectors mounted for direct fuel injection, as they face higher temperatures, resulting in excessive wear, mainly at the pintle/seat interface of the injector nozzle.

To address this problem, US 2019/0211720 A1 proposes injecting lubricant into the gaseous fuel supply line upstream of the fuel injectors. The lubricant is stored in a dedicated tank coupled to the fuel supply duct through a metering valve. A control unit operates the metering valve to regulate the amount of lubricant injected into the gaseous fuel based on engine operating conditions.

While this patent document provides a solution for lubricating dry fuel gas such as CNG, it remains rather silent on the details of implementation. One of the challenges in designing lubrication devices for hydrogen engines is the need for injecting small amounts (about 2 mm³ per shot) every minute into a 50 bar H₂ environment. There, it is desirable to keep the actuating energy as low as possible and be capable of ensuring that injection has occurred.

### OBJECT OF THE INVENTION

The object of the present invention is therefore to provide an improved lubricant dosing device for gaseous fuel delivery system without the aforementioned drawbacks.

### SUMMARY OF THE INVENTION

The present invention relates to a lubricant dosing device for a gaseous fuel delivery system of an internal combustion engine, in particular a hydrogen engine. The lubricant dosing device comprises:
a body having therein a pumping bore extending along a pumping axis (A) and defining, at an end, a pumping chamber which volume is varied by a piston reciprocating in said pumping bore;
an inlet section in the body through which lubricant fluid is supplied to the pumping chamber (24), wherein an inlet valve assembly is preferably arranged in the inlet section;
an outlet section in said body, in which an outlet valve assembly is arranged to control the discharge of pressurized lubricant fluid from the pressure chamber, said outlet valve assembly being configured as a check-valve with an outlet valve seat and an outlet valve member downstream thereof;
wherein the outlet valve member comprises a sealing surface adapted to cooperate with the outlet valve seat, the sealing surface being formed of or coated with a resilient polymer.

The present invention provides a lubricant dosing device that allows introducing lubricant into a gaseous fuel stream, in order to ensure that a certain level of lubricant is present in the fuel reaching the injectors. The invention permits to avoid issues of missing lubrication and wear risks at fuel delivery system components, in particular at the fuel injectors.

The outlet valve member is built from resilient polymer; or from another material (e.g. metal/steel), a sealing surface of the outlet valve member being coated with the resilient polymer. The resilient polymer is an elastic and compressible polymer, which can be compressed when an external force is applied and can retrieve its original shape when the external force is removed. The polymer is advantageously selected to be compatible with oil and gaseous fuel such as hydrogen. Elastomers are particularly preferred, in particular from the FKM family.

The use of such resilient polymer/elastomer provides a dynamic seal at the outlet valve, which allows for an enhanced compression force.

Although specifically designed for hydrogen engines, the invention is applicable to any kind of gaseous fuel, natural or resulting from synthesis, for example natural gas, methane, e-methane, etc. In some cases, the gaseous fuel may be stored in the fuel tank in partly liquid form.

The lubricant dosing device can be arranged at any appropriate location in the gaseous fuel delivery system, for example it may be arranged rather upstream in the circuit, close to the fuel tank, or before or after the fuel rail. If desirable, more than one lubricant dosing device can be arranged in the fuel delivery system, at the previously mentioned locations, or e.g. one lubricant dosing device per fuel injector.

In practice, the lubricant dosing device can be received in a support, which comprises fuel and oil channels and/or connections. Or the lubricant dosing device can be designed to include connectors/fittings to the oil supply and to the fuel supply line.

The outlet valve member may take any appropriate form or shape, in particular a ball, a pintle or a plate. As indicated before, the outlet valve member is either a polymer/elastomer member, or a metal member which is coated, at least on the sealing surface that will cooperate with the outlet valve seat, with the polymer/elastomer.

In embodiments, the outlet valve member is biased towards the outlet valve seat in closing direction by a first spring supported by a spring seat member; the outlet valve member is mounted in a cup-shaped guide element; the first spring is supported at one end by the spring seat member, and bears at its opposite end against the guide element; the spring seat member is fixed in the outlet section.

The spring seat member may comprise a base with a peripheral wall, and a cylindrical protrusion extending from the base towards the guide element, on which the first spring end is engaged.

In embodiments, the said cup-shaped guide element (which may be made of metal/steel) comprises an end wall and an annular wall extending therefrom, defining a recess in which the valve member is received. The annular wall defines an annular abutment surface surrounding a protruding portion of the valve member, the abutment surface being configured to come into abutment with the outlet valve seat when a predetermined compression state of the valve member is reached. Hence, when a certain degree of compression of the polymer valve member, or polymer coating, is reached, the abutment surface will come into contact with the valve seat, preventing further compression and thus potential damage of the outlet valve member.

The outlet valve assembly is configured to have a predefined opening pressure. The term ‘opening pressure’ defines the pressure to be reached in the pumping chamber in order to cause lifting of the outlet valve member. The present device is designed such that the opening pressure if of at least 50 bar, and e.g. up to 60, 70 or 80 bar.

The purpose of the present device is to deliver rather small volumes of oil into the stream of gaseous fuel. The present lubricant dosing device is advantageously configured such that the discharged volume is variable between 1 and 3 mm³, in particular at a pressure of at least 50 bar.

Lubricant fluid (Oil) is supplied to the present lubricant dosing device through the inlet section. This supply may be gravity fed (i.e. oil may be flow through or be sucked through the inlet section) or the supplied oil may be pressurized (engine oil or independent source).

In embodiments, an inlet valve assembly may be arranged in the inlet section, although this is not required.

Such inlet valve assembly may be configured as a check-valve with an inlet valve seat and an inlet valve member downstream thereof. The inlet valve member is biased towards the inlet valve seat in closing direction by a second spring that is supported by a control pin protruding in the pumping chamber towards said valve seat. The spring is engaged at one end on the control pin and bears at its opposite end against the inlet valve member. The end face of the control pin is at a predetermined distance from the guide element in closed position to form a lift stop.

In embodiments, pressure sensitive switching device is arranged to detect a predetermined pressure threshold in the pumping chamber, the switching device having a reciprocally arranged sensing pin having a tip exposed to the pressure in the pumping chamber. The pressure sensitive switching device is typically configured to detect a predetermined pressure that is greater than the opening pressure of the outlet valve.

Preferably, a head of the sensing pin is biased by a spring towards the pumping chamber in a rest position; and the spring has a predetermined force, which when overcome by the pressure in the pumping chamber, causes said sensing pin to close an electrical detection circuit.

The sensing device may comprise: a hollow housing fixed in a channel of said housing opening into said pumping chamber; a cylindrical insulating guide arranged at an open front end of the hollow housing, in which the sensing pin is slideably accommodated. A detection element is rearwardly arranged in the housing relative to the sensing pin, and insulated from the housing.

The detection element is, in use, at a predetermined voltage, whereby, when the spring force is overcome by pressure, the sensing pin moves rearward and comes into abutment with the detection element, putting the detection to ground through the spring and housing.

The detection element may be a pin element axially aligned with the sensing pin and surrounded by an annular control screw meshing with a threaded rear section in the housing. The spring is engaged on a front end of the detection element, resting at one end against the control screw and at the other end on the head of the sensing pin.

Conveniently, actuation of the lubricant dosing device may be carried out with an electrically controllable actuator having an actuating stem configured to selectively apply an actuating force to the piston to compress fuel in the pumping chamber.

According to another aspect, the invention relates to a gaseous fuel delivery system for an internal combustion engine comprising a fuel tank, a gaseous fuel filter, and means to provide one or more functions selected from shut-off, pressure regulation and pressure release, as well as at least one a lubricant dosing device as disclosed herein. The gaseous fuel may in particular be one of natural gas, methane, e-methane or hydrogen, but this should not be construed as limiting.

### BRIEF DESCRIPTION OF THE DRAWINGS

The present invention will now be described, by way of example, with reference to the accompanying drawings, wherein

FIG. 1 is a longitudinal section view through an embodiment of the present lubricant dosing device; and

FIG. 2 is a transversal cross-sectional view through the lubricant dosing device of FIG. 1.

### DETAILED DESCRIPTION OF PREFERRED EMBODIMENTS

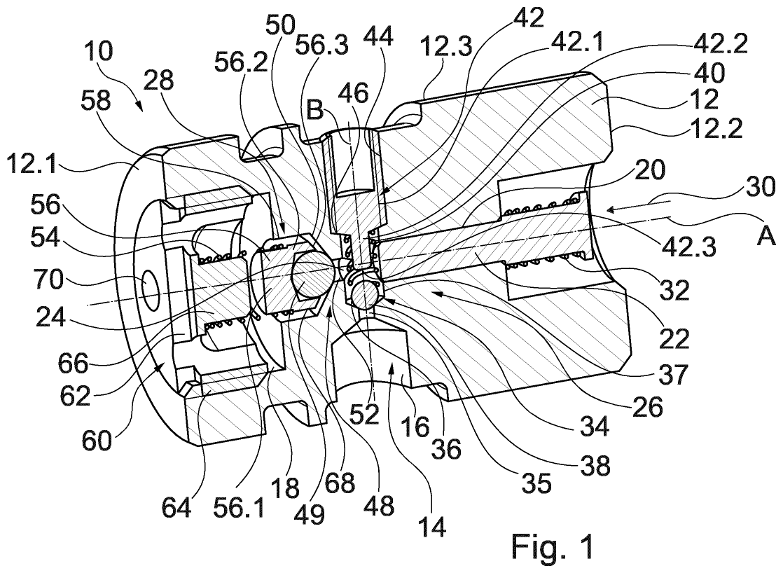

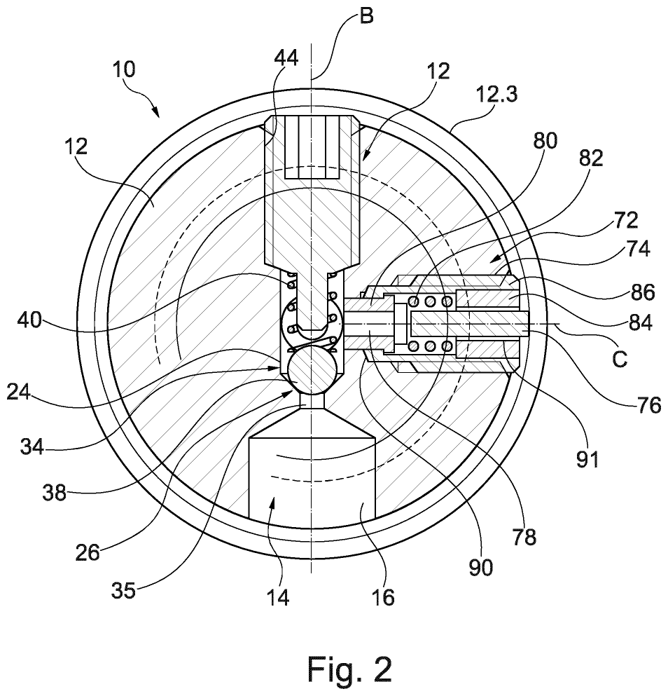

An embodiment of the present lubricant dosing device 10 is illustrated in FIGS. 1 and 2. Pressure regulator device 10 has been developed for application in hydrogen internal combustion engines, although it may be used with other gaseous fuels, e.g. CNG or fuel cell gas. In the following, for ease of speech, the terms fluid lubricant and oil are used as synonyms.

In this embodiment, lubricant dosing device 10 is designed as a unit or module that is integrated/received in a support that may be arranged at any appropriate location within the fuel delivery system, in particular upstream or downstream of the fuel rail. Such support may be built on a metal bloc (partly shown) with a cylindrical recess in which the lubricant dosing device is received.

Lubricant dosing device 10 is designed to permit selective introduction (or injection) of predetermined amounts of lubricant into the gaseous fuel flow. For the purpose of injector nozzle lubrication, any appropriate lubricants may be used, in particular oils, e.g. standard engine oil similar to that already present in the engine (depending on engine type and size).

The device 10 comprises a housing or body 12 with a gas passage 14 extending between an inlet section 16 (or inlet passage) for receiving lubricant fluid and an outlet section 18 (or outlet passage) through which the lubricant fluid is discharged. The inlet 14 is in communication with an oil reservoir (not shown); pressurized oil/lubricant is discharged through the outlet section 18 into a flow of gaseous fuel at a pressure of up to 20 to 40 bar, which is further guided to fuel injectors. Oil arrives at inlet section 16 through a channel provided in the support bloc (not shown). On the outlet side oil is discharged directly into a duct, pipe or channel (not shown) containing the pressurized gaseous fuel stream.

Lubricant (liquid oil) may be stored in the lubricant reservoir at atmospheric pressure and the lubricant dosing device 10 permits pressurizing the oil to levels higher than the pressure in the fuel conduit/passage in which it is injected. Whereas the lubricant is pressurized to a pressure above the fuel pressure in the supply line, the pressure level may still be adapted depending on application and required gas flow rate.

The body 12 is made out of metal, e.g. stainless steel, and has a generally cylindrical shape extending along an axis A, whereby the body 12 has a first end 12.1, a second end 12.2 and a side 12.3. In this embodiment, the inlet section 16 is located laterally, on the side 12.3, whereas the outlet is at the first end 12.1 of the body 12.

The body 12 is provided with a pumping bore 20 extending along a pumping axis, which is here coaxial with axis A. The pumping bore 20 opens into the passage 14. In pumping bore 20, a piston 22 (or plunger) is guided to perform reciprocal displacements varying the volume of a pumping chamber 24 that is defined by a passage portion between inlet and an outlet valves and the corresponding portion of pumping bore 20 delimited by piston 22. Sealing at the piston 22 can be achieved with a tight clearance and/or using a piston rod seal.

As can be seen, inlet section 16 opens into pumping chamber 24 and is controlled by an inlet valve assembly 26 (or simply inlet valve). Flow out of the pumping chamber 24 occurs through outlet section 18 and is controlled by an outlet valve assembly 28 (or simply outlet valve).

Typically, the plunger 22 is actuated, via the open end of plunger bore 20, based on input from an electrically powered actuator (not represented), that can be selectively actuated. The actuator may be a solenoid actuator. Energizing the actuator will cause outward movement of its actuating stem, which will apply an actuating force onto the piston 22 in the direction of arrow 30, i.e. in the compression direction. Spring 32 biases the piston 22 in the opposite direction, towards a rest position. It may be noted that in FIG. 1 the piston 22 is in the innermost position, i.e. at the end of the compression stroke (it cannot move further to the left).

Inlet valve 26 is configured to allow oil, arriving through inlet section 16 from the oil reservoir to enter pumping chamber 24. The inlet valve 26 is configured as a check valve (one-way flow) that allows oil to enter the pressure chamber 24 and that will to close during the compression stroke to allow pressure build-up. Inlet valve 26 here comprises a valve seat 34 at the interface between inlet section 16 and pressure chamber 24. The valve seat 34 surrounds the passage 14 and comprises an annular sealing surface 36 that surrounds the flow orifice 35 towards the pressure chamber 24. Sealing surface 36 is arranged on the side of the pressure chamber 24 (i.e. downstream seat 34). A ball shaped valve member 38 is arranged to cooperate with the seat 34. Valve member 38 is moveable between a closed position, in which is rests on the annular sealing surface 36 and closes the flow through orifice 35, and an open position in which it is spaced from the inlet valve seat 34 and allows oil to enter the pressure chamber 24. The valve member 38 is biased by a second spring 40 into closing position. As will be understood, during the compression phase the valve member 38 is additionally forced towards the closing position by the hydraulic pressure.

The valve member 38 may be a metal ball, in particular made from wear resistant steel, e.g. 100Cr6 or the like.

The portion 37 of passage 14 directly downstream of seat 34 has a cross section D₃₇ that is adapted to provide some axial guiding to valve member however with proper annular clearance to allow oil flow.

For example, passage portion 37 may have a diameter D₃₇ that is between that is between 1.2 and 1.8 times the diameter of ball 38, preferably 1.4 to 1.6

Reference sign 42 designates a control pin that is used to maintain spring 40 and control lift of valve member 38. Control pin 42 is arranged in a channel 44 (or port) through the body 12 that opens in the pumping chamber 24. Control pin 42 comprises a base portion 42.1 supporting a pin portion 42.2, of narrower diameter. Base portion 42.1 is screwed in channel 44 against an end shoulder 46, providing a fluid sealing of pumping chamber 24. Pin portion 42.2 protrudes inside pumping chamber 24 and extends towards the inlet valve assembly 26. Spring 40 is fitted around pin portion 42.2 at one end and bears at the other end on valve member 42. Axis B in FIG. 1 illustrates the lift direction of the valve member 38. In the present design this direction is transversal, in particular perpendicular to axis A. Channel 44 also extends along axis B and so does control pin 42, the end face 42.3 of its pin portion 42.2 facing the valve member 38. As will be understood, the length of pin portion 42.2 will determine the gap between its end face and the valve member 38, and thus act as end stop for the valve member 38 when lifting from seat 34. Hence control pin 42 defines the lift of inlet valve 26. The distance between end face 42.3 and valve member 38 in closed position is preferably between 0.5 and 1 times the diameter of ball 38.

Outlet valve assembly 28, in turn, allows pressurized lubricant fluid to be discharged from pumping chamber 24, into a stream of hydrogen. Outlet valve 28 is also designed as a check valve, i.e. allowing only one-way flow. Reference sign 48 designates a second valve seat, cooperating with an outlet valve member 49, at the interface between the pressure chamber 24 and outlet section 18. The second valve seat 48 includes an annular sealing surface 50 that surrounds an outlet flow orifice 52 leading from the pressure chamber 24 to the outlet section 18. The annular sealing surface 50 is located on the downstream side and the valve member 49 is thus moveably arranged downstream of the seat 48. The valve member 49 is elastically biased by a third spring 54 into a closing position where it rests on the seat 48 and closes in a fluid tight manner the flow orifice 52. The surface of valve member 49 that contacts the valve seat 48 is referred to as sealing surface (not shown).

In the shown embodiment, the valve member 49 takes the form of a ball that is received in a cup-shaped guide element 56, from which it protrudes by at least 20, 25 or 30%. Guide element 56 is received in a guide section 58 of passage 16 having an adapted cross-section configured such as to maintain alignment of the guide 56 and ball 49 relative to the seat 48, while having a peripheral clearance to allow flow of oil.

Valve member 49 may be a ball made from polymer material, in particular the ball 49 may comprise or consist of an elastomer (e.g. of the FKM family).

Alternatively, the valve member may be a metal (steel) ball, or other shape (e.g. pintle) with a polymer/elastomer coating over the entire surface of ball/member, or at least over a surface corresponding to the sealing surface.

When using a ball member integrally made from polymer/elastomer or entirely coated therewith, any portion of the elastomer can form the sealing surface.

The use of a resilient/compressible material for or on the valve member allows some compression of the valve member 49 on the outlet valve seat 48, since a strong contact pressure is required to ensure a good sealing against hydrogen. An elastomer is generally preferred for its elasticity/resilience. The polymer should also be compatible with the use in the environment of hydrogen and oil. Elastomers from the FKM family may be employed, but this should not be seen as limiting.

Referring more specifically to guide element 56, it comprises a bottom wall 56.1 and an annular wall 56.2, which define the recess in which valve member 49 is arranged. The free end of annular wall 56.2 defines an annular abutment surface 56.3 that surrounds the portion of the valve member 49 protruding from the guide element 56. This abutment surface 56.3, and in particular its axial position relative to the front portion of the valve member 49, is configured to come into abutment on the outlet valve seat 48, in case of pressure peaks or excessive spring force, to avoid over-compressing/damaging the elastomer of the valve member 49.

Guide section 58 opens into outlet section 18, which has a comparatively broader cross section. Reference sign 60 designates a spring seat member that is fixed by screwing inside outlet section 18. Spring seat member 60 is shaped as a blind sleeve having a plate 62 with an annular peripheral wall 64. The plate member 62 comprises a central cylindrical protrusion 66 that receives one end of spring 54, the opposite end thereof resting on an annular shoulder 68 surrounding guide element 56.

One or more through holes 70 are arranged in plate 62 to allow flow of oil out of the outlet section 18. This spring seat member 60, with protrusion 66, also controls the lift of valve member 49.

Here again, cylindrical protrusion 66 may advantageously be used to limit the lift/stroke of guide member 56 / valve member 49, thereby limiting leakage of hydrogen. Preferably, the axial distance between the front side of cylindrical protrusion 66 and the facing side of bottom 56.1 of guide element 56, in the closed position of the outlet valve, is less than 250 um, preferably less than 150 um or even less than 100 or 80 um.

In embodiments, the device 10 may be designed such that a volume of 1, 2, 3 mm3 of oil, or possibly up to 5 or 10 mm3 of oil, can be discharged through the outlet valve 28—at a pressure of at least 50 bars.

In embodiments, the pumping chamber may have a volume of up to 20 mm³.

The outlet valve assembly 28 with third spring 54 may be configured to present an opening pressure between 50 and 100 bars, depending on embodiments.

FIG. 2 illustrates a cross section of lubricant dosing device 10 in a plane containing axis B and perpendicular to axis A.

Reference sign 72 designates a sensor assembly referred to as pressure sensitive switching device, which is provided to detect an injection event, i.e. when the pressure in the pumping chamber will rise to a predetermined pressure greater than the opening pressure of the outlet valve 28.

Pressure sensitive switching device 72 is arranged in a channel 74 (or port) in body 12 that opens into pumping chamber 24. Channel 74 extends along axis C and is e.g. transversal to axis A, in particular perpendicular thereto.

Pressure sensitive switching device 72 comprises a detection pin 76, a sensing pin 78, an insulating guide 80, a spring 82 and a control screw 84 arranged in a housing formed by a hollow screw 86.

Hollow screw 86 is arranged in channel 74 and is in abutment against a shoulder 90 to provide sealing with the pumping chamber 24. Sensing pin 78 is arranged at an inner open end of hollow screw 74 such that a tip of sensing pin is exposed to the pressure in the pumping chamber. Sensing pin 78 is insulated from the body 12 by hollow cylindrical (electrically) insulating guide 80, in which it can move along axis C with small clearance. Sensing pin 78 has a head on which rests one end of a fourth spring 82 that biases sensing pin 78 towards the pumping chamber 24. At its other end, spring 82 rests on control screw 84. Control screw 84 is formed as a sleeve with an outer thread cooperating with an inlet threaded section in hollow screw 86. Detection pin 76 is received in control screw 84 and has an electrically insulating coating 91.

In use, detection pin 76 is set at a predetermined voltage (via wire/terminal) and connected to a controller or ECU, whereas the hollow screw 84 is at ground potential.

To sum up, this pressure sensitive switching device 10 relies on the principle of using a small piston (the sensing pin 78) insulated from the body 12 and which is submitted to the pressure in the pumping chamber 24. As soon the pressure rises above a given set value defined by the spring 82 the sensing pin 78 moves (retracting), creating an electrical contact with the detection pin 76. The electrical contact is then established between the main body (ground) through the spring 82, the sensing pin 78 and the detection pin 76 which is insulated from the surrounding components. An electrical link is thus created toward the controller/ECU detection driver to sense the ground event.

In practice, the switching device 72 is configured such that the set value to trigger the electrical contact is a pressure that is higher than the fuel/H₂ pressure downstream of the outlet section 18 and smaller than the maximum pumping chamber pressure. In particular the set value is higher than the opening pressure of the outlet valve assembly.

Preferably, the sensing pin 78 has a low clearance to the insulating guide 80 in order to avoid pumping loss. Preferably, the volume inside switching device 72 is kept small enough so that it can its effect is negligible on the pumping efficiency.

The spring 82 may be set with the specific screw 84, but the screw 84 can alternatively be replaced by a pressed part at the required position ensuring the specific required force. The required force can be measured during the setting operation. The spring 82 can be set to suit the outlet pressure level selected for the system with the same components.

The position of the detection pin 76 is advantageously adjusted to minimize the sensing pin displacement. This may be achieved either by a thread or a pressing force with a fit in given position. Sensing pin travel can be measured during the setting operation.

The present lubricant dosing device operates on the general principle of a pumping system using an inlet valve and an outlet valve, fed from a lubrication oil source at low pressure.

The driving force is achieved with an axial solenoid actuator having enough force and stroke using battery voltage source. It should however be noted that the design according to the invention allows operating the device 10 to be driven with a solenoid force of about 45 N, which is easily achievable with existing, low cost actuator technologies.

The present lubricant dosing device 10 may be controlled directly or indirectly by the engine control unit (ECU—not shown). The ECU is conventionally operatively connected to a number of sensors and actuators for controlling and monitoring engine operation, as it is known in the art. The ECU may be a conventional microcomputer including: microprocessor unit, input/output ports, read-only memory, random access memory, and a conventional data bus. ECU is conveniently configured to receive various signals from sensors coupled to the internal combustion engine and send command signals to actuators in components in the vehicle, such as a throttle (not shown), fuel injectors, etc. Additionally, the ECU is also configured to receive pedal position (PP) from a pedal position sensor coupled to a pedal actuated by an operator.

The ECU may be further configured to control the lubricant dosing device 10 by regulating the amount of lubricant discharged via outlet section 18 into the gaseous fuel stream based on one or more engine operating conditions. In general, the ECU commands the various actuators to reach a desired engine performance, depending on user demand, and as reflected by parameters such as engine speed and/or load. The gaseous fuel flow may also depend on speed/load and is regulated by the ECU.

In this context, it may thus be noted that the flow of gaseous fuel (flow rate or pressure) can be used as main input for the required lubricant quantity, in order to achieve a target oil concentration/ratio.

1. A lubricant dosing device for a gaseous fuel delivery system of an internal combustion engine, the lubricant dosing device comprising:
a body having therein a pumping bore extending along a pumping axis and defining, at an end, a pumping chamber which volume is varied by a piston reciprocating in said pumping bore;
an inlet section in said body through which lubricant fluid is supplied to said pumping chamber;
an outlet section in said body, in which an outlet valve assembly is arranged to control the discharge of pressurized lubricant fluid, said outlet valve assembly being configured as a check-valve with an outlet valve seat and an outlet valve member downstream thereof;
wherein said outlet valve member comprises a sealing surface adapted to cooperate with said outlet valve seat, said sealing surface being formed of, or coated with, a resilient polymer.

2. The lubricant dosing device according to claim 1, wherein
said outlet valve member is biased towards said outlet valve seat in a closing direction by a first spring supported by a spring seat member;
said outlet valve member is mounted in a cup-shaped guide element;
said first spring is supported at one end by said spring seat member, and bears at its opposite end against said guide element;
said spring seat member is fixed in said outlet section.

3. The lubricant dosing device according to claim 2, wherein said spring seat member comprises a base with a peripheral wall, and a cylindrical protrusion extending from said base towards said guide element, on which said first spring end is engaged.

4. The lubricant dosing device according to claim 2, wherein
said cup-shaped guide element comprises an end wall and an annular wall extending therefrom, defining a recess in which said valve member is received;
said annular wall defining an annular abutment surface surrounding a protruding portion of the valve member said abutment surface being configured to come into abutment with the outlet valve seat when a predetermined compression state of the valve member is reached.

5. The lubricant dosing device according to claim 1, wherein said outlet valve assembly has an opening pressure of at least 50 bar.

6. The lubricant dosing device according to claim 1, wherein said outlet valve member is ball-shaped and made of polymer; or said outlet valve member is a metal ball coated with a polymer.

7. The lubricant dosing device according to claim 1, wherein said resilient polymer is an elastomer,

8. The lubricant dosing device according to claim 1, wherein said lubricant dosing device is configured such that the discharged volume is variable between 1 and 3 mm3.

9. The lubricant dosing device according to claim 1, wherein
said inlet valve assembly is configured as a check-valve with an inlet valve seat and an inlet valve member downstream thereof;
said inlet valve member is biased towards said inlet valve seat in a closing direction by a second spring that is supported by a control pin protruding in said pumping chamber towards said valve seat;
said spring is engaged at one end on said control pin and bears at its opposite end against said inlet valve member;
wherein an end face of said control pin is at a predetermined distance from the inlet valve member in a closed position to form a lift stop.

10. The lubricant dosing device according to claim 1, wherein a pressure sensitive switching device is arranged to detect a predetermined pressure threshold in said pumping chamber, said switching device having a reciprocally arranged sensing pin having a tip exposed to the pressure in said pumping chamber.

11. The lubricant dosing device according to claim 10, wherein
a head of said sensing pin is biased by a spring towards said pumping chamber in a rest position;
wherein said spring has a predetermined force, which when overcome by the pressure in said pumping chamber, causes said sensing pin to close an electrical detection circuit.

12. The lubricant dosing device according to claim 11, wherein said sensing device comprises:
a hollow housing fixed in a channel of said housing opening into said pumping chamber;
a cylindrical insulating guide arranged at an open front end of said hollow housing, in which said sensing pin is slideably accommodated;
a detection element, rearwardly arranged in said housing relative to said sensing pin, and insulated from said housing;
wherein said detection element is, in use, at a predetermined voltage, whereby, when said spring force is overcome by pressure, said sensing pin moves rearward and comes into abutment with said detection element, putting the detection to ground through the spring and housing.

13. The lubricant dosing device according to claim 12, wherein
said detection element is a pin element axially aligned with said sensing pin and surrounded by an annular control screw meshing with a threaded rear section in said housing said spring is engaged on a front end of said detection element, resting at one end against said control screw and at the other end on said head of said sensing pin.

14. The lubricant dosing device according to claim 1, comprising an electrically controllable actuator having an actuating stem configured to selectively apply an actuating force to said piston to compress lubricant fluid in said pumping chamber.

15. A gaseous fuel delivery system for an internal combustion engine comprising a fuel tank, a gaseous fuel filter, and means to provide one or more functions selected from shut-off, pressure regulation and pressure release, as well as at least one a lubricant dosing device according to claim 1.

16. The system according to claim 15, wherein said gaseous fuel is one of natural gas, methane, e-methane, and hydrogen.

17. The lubricant dosing device according to claim 1, wherein an inlet valve assembly is arranged in said inlet section.
